(19) United States
(12) Patent Application Publication
(10) Pub. No.: US 2026/0290702 A1
(43) Pub. Date: Sep. 24, 2026

(54) LAMINATED CERAMIC CAPACITOR AND METHOD OF MANUFACTURING LAMINATED CERAMIC CAPACITOR

(71) Applicant: TAIYO YUDEN CO., LTD., Tokyo (JP)

(72) Inventor: Shohei KITAMURA, Tokyo (JP)

(21) Appl. No.: 19/569,192

(22) Filed: Mar. 17, 2026

(30) Foreign Application Priority Data
Mar. 19, 2025 (JP) 2025-045844

(51) Int. Cl. H01G 4/30; H01G 4/12

(52) U.S. Cl. CPC H01G 4/30; H01G 4/1227

(57) ABSTRACT

One object is to provide a laminated ceramic capacitor with a high bending strength without degradation of bias characteristics. An aspect of the present invention provides a laminated ceramic capacitor including a body, a first external electrode, and a second external electrode. The body includes a first internal electrode layer, a second internal electrode layer and a dielectric layer. The dielectric layer is disposed between the first internal electrode layer and the second internal electrode layer in a first direction. The dielectric layer contains a plurality of ceramic crystal grains. The dielectric layer contains a plurality of intergranular triple junctions located among three or more adjacent ceramic crystal grains. At least a part of the plurality of intergranular triple junctions contains a Cu-segregated portion where Cu is segregated. On the other hand, a grain boundary located between two adjacent ceramic crystal grains does not contain a Cu-segregated portion.

### CROSS-REFERENCE TO RELATED APPLICATIONS

This application is based on and claims the benefit of priority from Japanese Patent Application Serial No. 2025-045844 (filed on Mar. 19, 2025), the contents of which are hereby incorporated by reference in their entirety.

### TECHNICAL FIELD

The disclosure herein relates mainly to a laminated ceramic capacitor and a method of manufacturing the laminated ceramic capacitor. The disclosure herein also relates to a circuit module with the laminated ceramic capacitor and an electronic device with the circuit module.

### BACKGROUND

Laminated ceramic capacitors are installed in various electronic devices. Laminated ceramic capacitors have a plurality of dielectric layers and a plurality of internal electrode layers that are stacked on each other. Laminated ceramic capacitors have a capacitance-generating portion. In the capacitance-generating portion, internal electrode layers are opposed to each other in the lamination direction via dielectric layers. Upon application of voltage to the internal electrode layers during use of the laminated ceramic capacitors, capacitance is generated in the capacitance-generating portion.

Electronic devices having laminated ceramic capacitors installed thereon may be subjected to vibration and impact. To prevent damage due to vibration and impact, laminated ceramic capacitors should have a high bending strength.

In the laminated ceramic capacitor disclosed in Japanese Patent Application Publication No. 2021-009994 (“the '994 Publication”), the dielectric layers are densified in the margin surrounding the capacitance-generation region as viewed from the lamination direction. Densification of the dielectric layers in the margin can improve the strength of the margin. This laminated ceramic capacitor has a high bending strength because of the margin with the improved strength.

The laminated ceramic capacitor of the '994 Publication is produced as follows. First, a green laminate is prepared which has dielectric green sheets, which are the precursor of the dielectric layers, and internal electrode patterns, which are the precursor of the internal electrode layers, and this green laminate is placed into a firing furnace. Next, the firing furnace in which the green laminate is placed is heated up to about 800° C. The laminate is then removed from the firing furnace during the firing process, and the semi-sintered laminate removed from the firing furnace is immersed in a sol of a compound having a low melting point. By immersing the semi-sintered laminate in the sol, the compound having the low melting point is absorbed into the laminate. Next, the laminate that has absorbed the compound having the low melting point is placed back into the firing furnace to fully sinter the ceramic powder in the firing furnace. At this time, the compound having the low melting point absorbed in the laminate acts as a sintering agent, and therefore, the dielectric layers are densified at the margin of the laminate that contains the compound having the low melting point in a large amount.

In the laminated ceramic capacitor disclosed in the '994 Publication, a large amount of sintering agent (the compound having a low melting point) is segregated at the grain boundaries of ceramic crystal grains, as can be seen in a SEM image (FIG. 8). When elements other than those contained in the oxide (e.g., barium titanate) as the main component of the ceramic material are segregated at the grain boundaries, the bias characteristics of the laminated ceramic capacitor will degrade. The degradation of the bias characteristics refers to the phenomenon in which the relative permittivity of the dielectric layers decreases when a bias voltage is applied to the laminated ceramic capacitor. In the semi-sintered laminate of the '994 Publication, the ceramic crystal grains have not grown sufficiently, so the spacing between the crystal grains is wide. In the manufacturing method disclosed in the '994 Publication, the semi-sintered laminate with the wide spacing between crystal grains is immersed in a sol of the low-melting-point compound, so a large amount of the low-melting-point compound inevitably penetrates the grain boundaries between the crystal grains.

### SUMMARY

It is an object of the present disclosure to solve or alleviate at least part of the drawback mentioned above. One of the more specific objects of the present disclosure is to obtain a laminated ceramic capacitor with a high bending strength without degradation of bias characteristics.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

The various inventions disclosed herein may be collectively referred to as “the invention”. An aspect of the present invention provides a laminated ceramic capacitor including a body, a first external electrode, and a second external electrode. The body includes a first internal electrode layer, a second internal electrode layer and a dielectric layer. The dielectric layer is disposed between the first internal electrode layer and the second internal electrode layer in a first direction. The first internal electrode layer is mainly composed of Ni or Ni alloy. The second internal electrode layer is mainly composed of Ni or Ni alloy. The dielectric layer contains a plurality of ceramic crystal grains. The dielectric layer contains a plurality of intergranular triple junctions located among three or more adjacent ceramic crystal grains included in the plurality of ceramic crystal grains. At least a part of the plurality of intergranular triple junctions contains a Cu-segregated portion where Cu is segregated. On the other hand, a grain boundary located between two adjacent ceramic crystal grains included in the plurality of ceramic crystal grains does not contain a Cu-segregated portion.

### Advantages

According to an embodiment of the invention disclosed herein, it is possible to inhibit the degradation of bias characteristics in laminated ceramic capacitors having a high bending strength.

### BRIEF DESCRIPTION OF DRAWINGS

FIG. 1 is a perspective view schematically showing a laminated ceramic capacitor according to one embodiment of the disclosure.

FIG. 2 is a sectional view schematically showing a section of the laminated ceramic capacitor of FIG. 1 along the line I-I.

FIG. 3 is a sectional view schematically showing a section of the laminated ceramic capacitor of FIG. 1 along the line II-II.

FIG. 4 is a plan view showing the laminated ceramic capacitor of FIG. 1.

FIG. 5 is an enlarged sectional view showing a part of the section shown in FIG. 2 on an enlarged scale.

FIG. 6 is an enlarged sectional view showing, on an enlarged scale, a region near an intergranular triple junction in the section shown in FIG. 5.

FIG. 7 shows an example of a line profile reconstructed along a scanning line passing through the intergranular triple junction.

FIG. 8 shows an example of a line profile reconstructed along a scanning line passing through a grain boundary.

FIG. 9 is a flowchart showing a flow of a manufacturing method of a capacitor according to one embodiment of the disclosure.

### DESCRIPTION OF THE PREFERRED EMBODIMENTS

Various embodiments of the present invention will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a laminated ceramic capacitor 1 may be described with reference to the L, W, and T axes.

### (1) Laminated Ceramic Capacitor 1

### (1-1) Basic Structure of Laminated Ceramic Capacitor 1

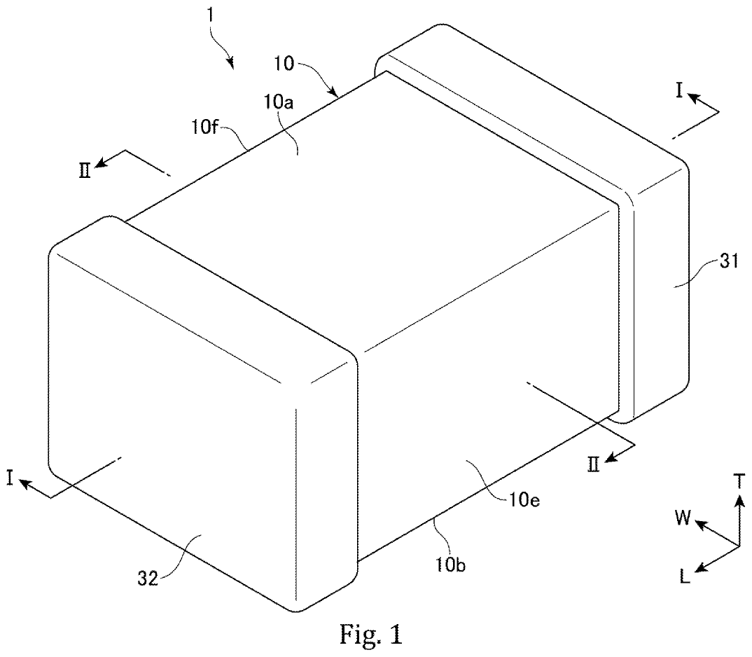

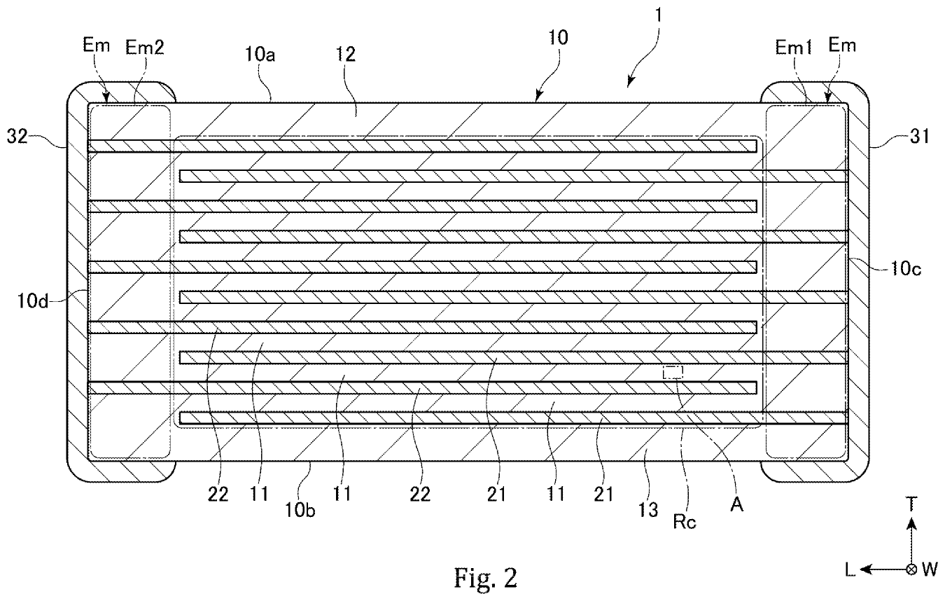

Referring to FIGS. 1 and 2, a description will now be given of the basic structure of a laminated ceramic capacitor 1 according to an embodiment. FIG. 1 is a perspective view showing the laminated ceramic capacitor 1 according to the embodiment. FIG. 2 is a sectional view schematically showing a section of the laminated ceramic capacitor 1 along the line I-I.

The laminated ceramic capacitor 1 has a body 10, and a first external electrode 31 and a second external electrode 32 provided on the body 10. The first external electrode 31 is spaced apart from the second external electrode 32.

The body 10 includes a plurality of dielectric layers 11, a plurality of first internal electrode layers 21, and a plurality of second internal electrode layers 22. In this specification, the first internal electrode layers 21 and the second internal electrode layers 22 may be referred to collectively as “the internal electrode layers” when it is not necessary to distinguish the first internal electrode layers 21 and the second internal electrode layers 22 from each other. In the body 10, each dielectric layer 11 is positioned between adjacent ones of the internal electrode layers. In the body 10, a first internal electrode layer 21 is provided on the top surface of a dielectric layer 11, and a second internal electrode layer 22 is provided on the bottom surface of the dielectric layer 11.

The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the Taxis, as in the illustrated embodiment, or may be along the L or W axis.

The dielectric layers 11 located at the opposite ends in the lamination direction may be referred to as cover layers. In the example shown in FIG. 2, an upper cover layer 12 is provided at the top end in the lamination direction, and a lower cover layer 13 is provided at the bottom end in the lamination direction. The upper cover layer 12 and the lower cover layer 13 may be formed of the same material as the dielectric layers 11. The upper cover layer 12 and the lower cover layer 13 may be a part of the body 10.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the embodiment shown in FIG. 2, the first internal electrode layer 21 is led through the first end surface 10c toward the outside of the body 10. The first internal electrode layer 21 is connected to the first external electrode 31 at one end of the body 10 in the L-axis direction. The second internal electrode layer 22 is led through the second end surface 10d toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out through the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface 10b. The first and second external electrodes 31 and 32 may be located on any of the surfaces of the body 10 as long as they are separated from each other.

In one aspect, the laminated ceramic capacitor 1 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the laminated ceramic capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the laminated ceramic capacitor 1 may be larger than the width thereof. In one aspect, the height of the laminated ceramic capacitor 1 may be larger than the width thereof. In one aspect, the width of the laminated ceramic capacitor 1 may be larger than the length thereof.

The laminated ceramic capacitor 1 may be mounted on an electronic circuit board. The electronic circuit board having the laminated ceramic capacitor 1 mounted thereon may be referred to as a circuit module. Various electronic components other than the laminated ceramic capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

### (1-2) Regions of Body 10

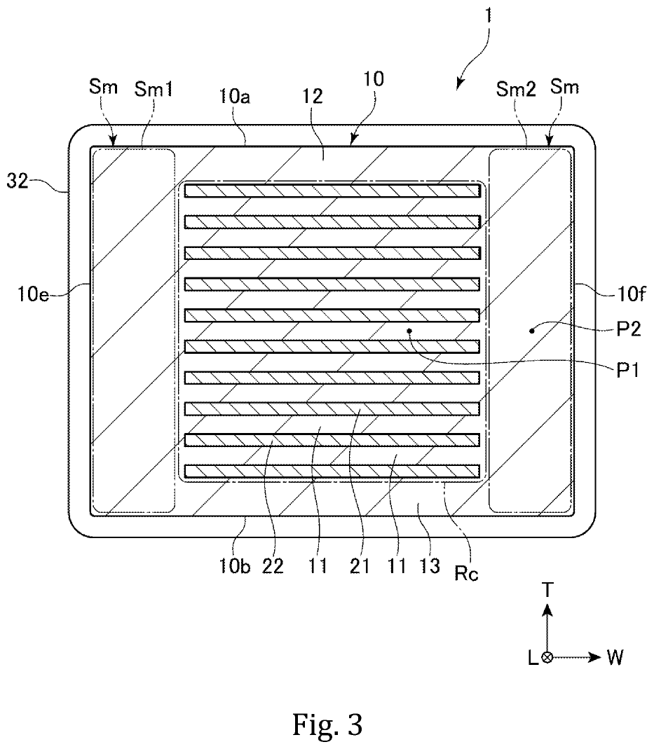

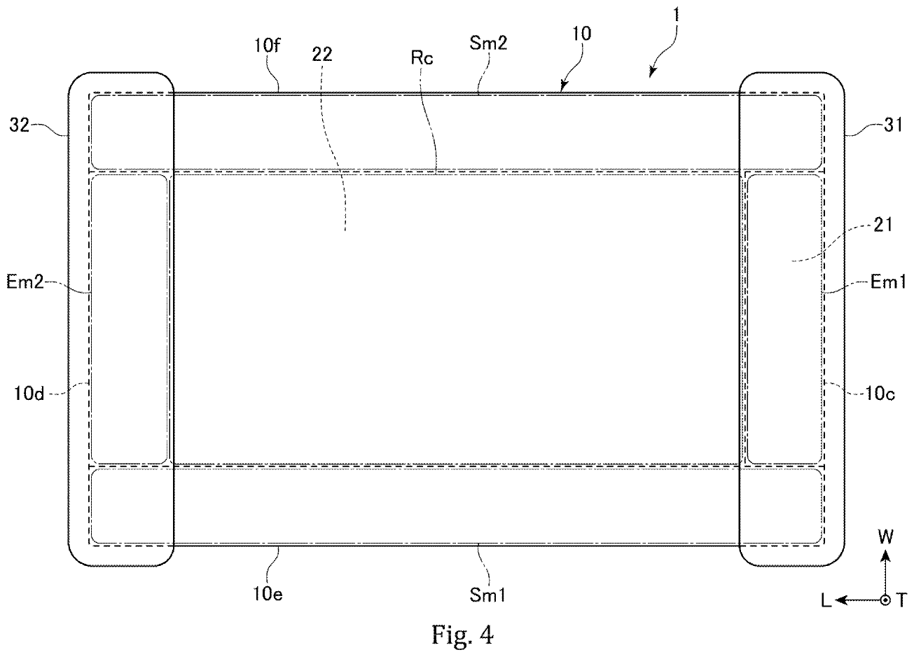

The body 10 may be partitioned into a plurality of regions. In the illustrated embodiment, the body 10 is partitioned at least into a capacitance-generating portion Rc, a first end margin Em1, a second end margin Em2, a first side margin Sm1, and a second side margin Sm2. The following describes each region of the body 10 with reference to FIGS. 2 to 4.

The capacitance-generating portion Rc is the region where the first and second internal electrode layers 21 and 22 face each other in the lamination direction. When voltage is applied between the first and second external electrodes 31 and 32, capacitance is generated between the first and second internal electrode layers 21 and 22. In other words, the capacitance-generating portion Rc is the region where capacitance is generated.

The first end margin Em1 is the region between the capacitance-generating portion Rc and the surface of the body 10 through which the first internal electrode layers 21 are led out. Since the first internal electrode layers 21 are led out through the first end surface 10c in the illustrated embodiment, the first end margin Em1 is located between the capacitance-generating portion Rc and the first end surface 10c. When viewed from the lamination direction, the first end margin Em1 contains the first internal electrode layers 21, but not the second internal electrode layers 22. In the first end margin Em1, adjacent ones of the first internal electrode layers 21 are opposed to each other with the dielectric layers 11 being therebetween as viewed in the lamination direction. The second end margin Em2 is the region between the capacitance-generating portion Rc and the surface of the body 10 through which the second internal electrode layers 22 are led out. Since the second internal electrode layers 22 are led out through the second end surface 10d in the illustrated embodiment, the second end margin Em2 is located between the capacitance-generating portion Rc and the second end surface 10d. When viewed from the lamination direction, the second end margin Em2 contains the second internal electrode layers 22, but not the first internal electrode layers 21. In the second end margin Em2, adjacent ones of the second internal electrode layers 22 are opposed to each other with the dielectric layers 11 being therebetween as viewed in the lamination direction. In this specification, the first and second end margins Em1 and Em2 may be referred to collectively as “end margins Em” when it is not necessary to distinguish the first and second end margins Em1 and Em2.

The first side margin Sm1 is the region where neither the first internal electrode layers 21 nor the second internal electrode layers 22 are present when viewed from the lamination direction. In the illustrated embodiment, the first side margin Sm1 is located between the capacitance-generating portion Rc and the first side surface 10e. Like the first side margin Sm1, the second side margin Sm2 is also the region where neither the first internal electrode layers 21 nor the second internal electrode layers 22 are present when viewed from the lamination direction. In the illustrated embodiment, the second side margin Sm2 is located between the capacitance-generating portion Rc and the second side surface 10f. In this specification, the first and second side margins Sm1 and Sm2 may be referred to collectively as “side margins Sm” when it is not necessary to distinguish the first and second side margins Sm1 and Sm2. The “end margins Em” and the “side margins Sm” may be referred to collectively as the “margins”.

### (1-3) Dielectric Layers 11

The dielectric layers 11 are made of a ceramic material. The dielectric layers 11 contain a plurality of crystal grains of the ceramic material (ceramic crystal grains). At least a part of the ceramic crystal grains has a core-shell structure. A ceramic crystal grain having a core-shell structure includes a core portion and a shell portion surrounding the core portion. The dielectric layers 11 contain grain boundaries each located between two adjacent ceramic crystal grains and a plurality of intergranular triple junctions located among three or more adjacent ceramic crystal grains. The grain boundaries and the crystal triple points will be described in detail below.

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxide contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 contain Cu-segregated portions where Cu is segregated. The Cu-segregated portions are present in at least some of the plurality of intergranular triple junctions contained in the dielectric layers 11, but not in the grain boundaries between the ceramic crystal grains. The Cu-segregated portions will be described below.

The dielectric layers 11 may contain elements that can originate from known sintering agents, in addition to the oxide as the main component and Cu. Examples of the known sintering agents are Mg (magnesium) and Mn (manganese).

The dielectric layers 11 may contain additive elements other than those mentioned above. In one aspect, the additive elements contained in the dielectric layers 11 are at least one element selected from the group consisting of Ni (nickel), Mo (molybdenum), Nb (niobium), Ta (tantalum), W (tungsten), V (vanadium), and Cr (chromium). The dielectric layers 11 may contain two or more of the above additive elements.

The dielectric layers 11 may contain oxides of rare earth elements. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of, for example, Co (cobalt), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.2 to 0.8 μm. An increased thickness of the dielectric layers 11 causes reduction in the capacitance of the laminated ceramic capacitor 1. In one embodiment, the thickness of the dielectric layers 11 is 0.8 μm or smaller, so as to inhibit the reduction in the capacitance. The thickness of the dielectric layers 11 may be 0.6 μm or smaller. A reduced thickness of the dielectric layers 11 causes degradation in the insulation reliability of the laminated ceramic capacitor 1. In one embodiment, the thickness of the dielectric layers 11 is 0.2 μm or larger, so as to ensure the insulation reliability. The thickness of the dielectric layers 11 may be 0.3 μm or larger. The thickness of the dielectric layers 11 may be 0.4 μm or larger.

### (1-4) First Internal Electrode Layers 21 and Second Internal Electrode Layers 22

In one aspect, the first internal electrode layers 21 contain Ni (nickel) or a Ni alloy as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more a base metal as the main component thereof.

The first internal electrode layers 21 can contain additive metal elements in addition to the main component metal element. The additive metal elements that can be contained in the first internal electrode layers 21 are, for example, metals that are more noble than the main component metal of the first internal electrode layers 21. The additive metal elements that can be contained in the first internal electrode layers 21 are one or more elements selected from the group consisting of, for example, Au, Sn, Cr, Y, In (indium), As (arsenic), Co, Cu, Ir (iridium), Mg, Os (osmium), Pd, Pt, Re (rhenium), Rh (rhodium), Ru (ruthenium), Se (selenium), Te (tellurium), W and Zn (zinc).

The description of the components of the first internal electrode layers 21 also applies to the components of the second internal electrode layers 22.

In an aspect, the thickness (the dimension in the T-axis direction) of each first internal electrode layer 21 and each second internal electrode layer 22 is 0.1 to 0.6 μm. A reduced thickness of the internal electrode layers causes a reduction in the continuity of the internal electrode layers. To maintain the continuity of the internal electrode layers, in one embodiment, the thickness of the internal electrode layers is 0.1 μm or larger. In one embodiment, the thickness of the internal electrode layers is 0.2 μm or larger. In one embodiment, the thickness of the internal electrode layers is 0.3 μm or larger. An increased thickness of the internal electrode layers causes a reduction in the number of internal electrode layers stacked together. A reduced number of internal electrode layers stacked together results in reduction in the capacitance of the laminated ceramic capacitor 1. To ensure the capacitance of the laminated ceramic capacitor 1, in one embodiment, the thickness of the internal electrode layers is 0.6 μm or smaller. In one embodiment, the thickness of the internal electrode layers is 0.5 μm or smaller. In one embodiment, the thickness of the internal electrode layers is 0.4 μm or smaller.

### (1-5) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag (silver), Pd (palladium), Au (gold), Pt (platinum), Ni (nickel), Sn (tin), Cu (copper), W (tungsten), Ti (titanium), and alloys of these.

### (1-6) Grain Boundaries 42 and Intergranular Triple Junctions 43

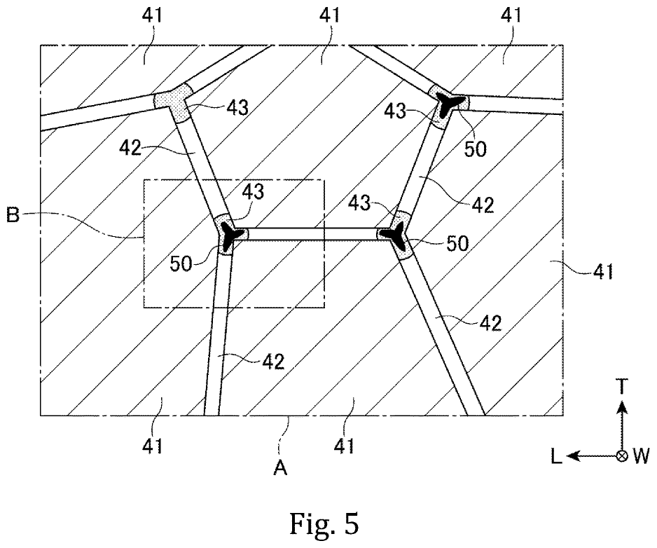

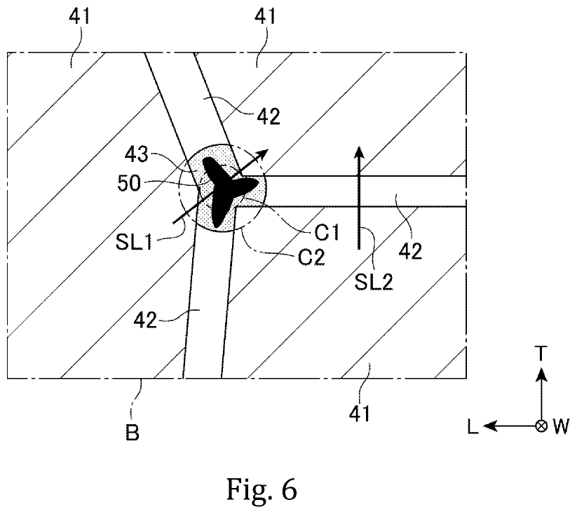

With further reference to FIGS. 5 and 6, a description will now be given of the Cu-segregated portions contained in the dielectric layers 11. FIG. 5 is an enlarged sectional view of the region A, which is a part of the section of the body 10 shown in FIG. 2, and FIG. 6 is an enlarged sectional view of the region B, which is a part of the region A. The region A is a region within the dielectric layers 11 that appear in the sectional surface of the body 10 cut along the LT plane. The region A can be set at any position within the dielectric layers 11. For example, the region A may be within the end margins Em. The region A may also be within the side margins Sm.

As shown in FIG. 5, each of the dielectric layers 11 contains a plurality of ceramic crystal grains 41. Adjacent ones of the ceramic crystal grains 41 are separated from each other by the grain boundaries 42 and the intergranular triple junctions 43. Thus, the dielectric layer 11 is a polycrystalline body containing a plurality of ceramic crystal grains 41.

Each of the grain boundaries 42 is a boundary between two adjacent ceramic grains 41. The two adjacent crystal grains 41 are separated from each other by the grain boundary 42.

Each of the intergranular triple junctions 43 is a region surrounded by three or more adjacent ceramic crystal grains 41. FIG. 5 shows four intergranular triple junctions 43. Each of these four intergranular triple junctions 43 is surrounded by three adjacent ceramic crystal grains 41.

Both the grain boundaries 42 and the intergranular triple junctions 43 are regions between ceramic crystal grains 41. The boundary between a grain boundary 42 and an intergranular triple junction 43 can be defined, for example, as follows. First, as shown in FIG. 6, focus on a region surrounded by three ceramic crystal grains 41 in the section of the body 10, and draw a circle C1 tangent to each of the three ceramic crystal grains 41 surrounding this region. Next, draw a circle C2 with a radius twice the radius of the circle C1 so as to be concentric with the circle C1. The arc of the circle C2 drawn in this way can be the outer edge of the intergranular triple junction 43. Thus, the arc of the circle C2 can be the boundary between the intergranular triple junction 43 and the grain boundary 42.

### (1-7) Cu-Segregated Portions 50

The intergranular triple junctions 43 contain Cu-segregated portions 50 where Cu is segregated. On the other hand, the grain boundaries 42 do not contain Cu-segregated portions 50. The Cu-segregated portions 50 are regions that occupy a part of the intergranular triple junctions and contain Cu at a higher concentration than other regions of the dielectric layers 11. The Cu-segregated portions 50 are not necessarily present in all of the plurality of intergranular triple junctions 43 in the dielectric layers 11. The Cu-segregated portions 50 are present in at least a part of the plurality of intergranular triple junctions 43 in the dielectric layers 11. The region A shown in FIG. 5 contains four intergranular triple junctions 43, three of which contain Cu-segregated portions 50. The Cu-segregated portions 50 have, for example, an outer diameter of 10 to 30 nm in the section of the body 10 (e.g., the LT plane shown in FIG. 5). The outer diameter of a Cu-segregated portion 50 is expressed, for example, as the distance between a pair of farthest points in the outer edge of the Cu-segregated portion 50.

The Cu-segregated portions 50 are formed by concentration of Cu contained in the raw material of at least one of the dielectric layers 11 and the internal electrode layers. As described above, the dielectric layers 11 may contain as their main component an oxide with a perovskite structure represented by a chemical formula ABO₃. The Cu atoms contained in the raw material can be dissolved as a solid solution in the ceramic crystal grains 41 by being substituted for either element in the A or B site of the main component oxide of the dielectric layers 11. However, the Cu atom has a smaller ionic radius than the elements that are coordinated at the A or B site of the main component oxide that forms the ceramic crystal grains 41, so substitution of Cu is unlikely to occur at the A and B sites of the main component oxide. For example, when the main component oxide is barium titanate, Ba is located at the A site and Ti at the B site, but the ionic radius of Cu is significantly smaller than those of Ba and Ti, so Cu is unlikely to be dissolved as a solid solution in the barium titanate crystal. Therefore, in the dielectric layers 11, which is mainly composed of an oxide with a perovskite structure, the amount of Cu contained in the ceramic crystal grains 41 is minute. In addition, as mentioned above, the grain boundaries 42 contain no Cu-segregated portions. Therefore, the Cu atoms contained in the raw material are concentrated at the intergranular triple junctions 43 to form Cu-segregated portions 50.

In the laminated ceramic capacitor 1, since no Cu-segregated portions 50 are present in the grain boundaries 42 of the ceramic crystal grains 41, the degradation of bias characteristics due to segregation of Cu in the grain boundaries 42 can be inhibited.

The presence of Cu-segregated portions 50 in the intergranular triple junctions 43 and the absence of Cu-segregated portions 50 in the grain boundaries 42 can be confirmed, for example, as follows. To begin with, the laminated ceramic capacitor 1 is embedded in resin, and the laminated ceramic capacitor 1 embedded in the resin is ground to near the middle in the W-axis direction, so that an LT surface becomes an observation surface. An observation region is set within a dielectric layer 11 in the sectional surface of the laminated ceramic capacitor 1 exposed by this grinding process, and TEM-EDS (Transmission Electron Microscope Energy Dispersive X-ray Spectroscopy) is used to obtain mapping images of the quantitative elements. When the main component of the dielectric layers 11 is barium titanate and the main component of the first internal electrode layers 21 and the second internal electrode layers 22 is Ni, the quantitative elements include Ba, Ti, Ni, and Cu. For example, the EDS measurements involve measuring the intensities of the Ba Lα, Ti Kα, Ni Kα, and Cu Kα lines to obtain mapping data for the quantitative elements.

Next, a line analysis is performed based on the mapping data obtained. For example, as shown in FIG. 6, a scanning lines SL1 extends through the intergranular triple junction 43, and a scanning line SL2 extends through the grain boundary 42. Along the scanning lines SL1 and SL2, the mapping data of the quantitative elements are reconstructed to create a line profile for each of the quantitative elements. When the scanning line SL1 is set to extend through an intergranular triple junction where a Cu-segregated portion 50 is present, the scanning line SL1 passes through the Cu-segregated portion 50 generated in the intergranular triple junction 43. Since no Cu-segregated portion 50 is present in the grain boundary 42, the scanning line SL2 does not pass through a Cu-segregated portion 50. The lengths of the scanning lines SL1 and SL2 are 5 to 20 nm, for example. The lengths of the scanning lines SL1 and SL2 can be varied according to the dimensions of the intergranular triple junction 43 and the grain boundary 42.

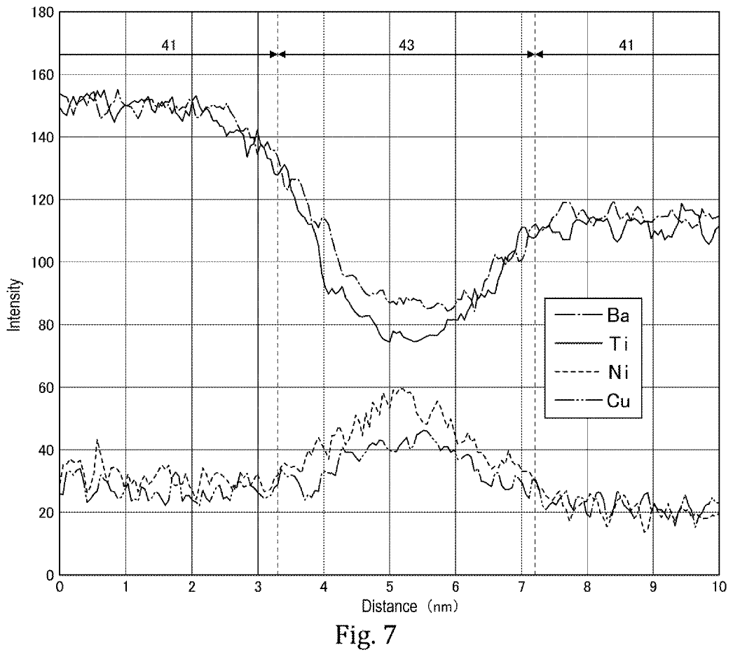

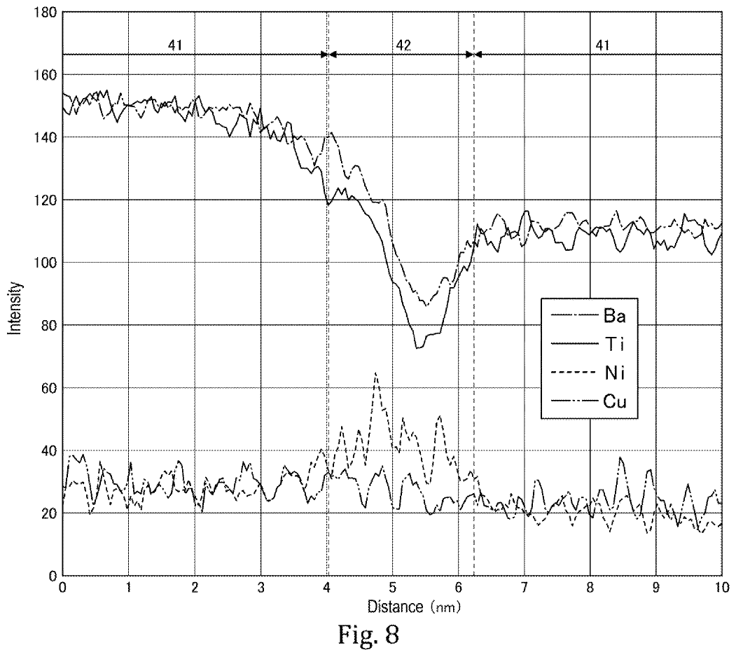

FIG. 7 shows an example of the line profiles obtained by reconstructing the mapping data along the scanning line SL1, and FIG. 8 shows an example of the line profiles obtained by reconstructing the mapping data along the scanning line SL2. In FIGS. 7 and 8, the horizontal axis represents the detection position on the scanning lines SL1 and SL2, and the vertical axis represents the detection intensity calculated based on the respective counts of Ba, Ti, Ni, and Cu at each detection position.

The presence of the Cu-segregated portion 50 in the intergranular triple junction 43 can be confirmed based on the line profiles along the scanning line SL1 extending through the intergranular triple junction 43 shown in FIG. 7, as described below. In FIG. 7, the region between the position at about 3.3 nm and the position at about 7.2 nm from the scan starting position corresponds to the intergranular triple junction 43. The detection intensities of Ba and Ti in the intergranular triple junction 43 is lower than those in the ceramic crystal grains 41, while the detection intensity of Ni in the intergranular triple junction 43 is higher than that in the ceramic crystal grains 41. The higher detection intensity of Ni in the intergranular triple junction 43 is due to the migration of Ni, the main component of the internal electrode layers, through the grain boundaries 42 to the intergranular triple junction 43 during firing. As shown in FIG. 7, the line profile of the Cu element has a gentle peak in the intergranular triple junction 43. The presence of the peak in the line profile of the Cu element in the intergranular triple junction 43 confirms the presence of a Cu-segregated portion 50 containing segregated Cu in the intergranular triple junction 43. In the Cu line profile, the Cu peak can be defined as the part where the Cu count is at least 30% larger than the average Cu count in the Cu line profile.

The dielectric layers 11 contain a large number of intergranular triple junctions 43. The Cu-segregated portions 50 are not necessarily contained in all the intergranular triple junctions 43. In other words, at least some of the numerous intergranular triple junctions 43 contained in the dielectric layers 11 contain the Cu-segregated portions 50. In one aspect, at least 30% of all the intergranular triple junctions 43 contained in the dielectric layers 11 contain the Cu-segregated portions 50. To improve the sinterability of the dielectric layers 11, the raw material should contain Cu at a high concentration. During firing, the Cu atoms added at a high concentration to the raw material should not remain in the grain boundaries 42 but should be migrated to the intergranular triple junctions 43 and concentrated in the intergranular triple junctions 43, resulting in the Cu-segregated portions 50 formed in a larger number of intergranular triple junctions 43 contained in the dielectric layers 11. Note that even when Cu is added to the raw material at a high concentration, no Cu-segregated portion 50 is formed in the grain boundaries 42.

When the Cu-segregated portions 50 are contained in a predetermined percentage (e.g., 30%) or more of all the intergranular triple junctions 43 in the dielectric layers 11, the sinterability of the dielectric layers 11 can be enhanced without degrading the bias characteristics of the laminated ceramic capacitor 1. To determine the percentage of the intergranular triple junctions 43 having a Cu-segregated portion 50 formed therein in a dielectric layer 11, the line analysis described above may be performed on 20 intergranular triple junctions 43 in the dielectric layer 11, for example, thereby to count the intergranular triple junctions 43 having the Cu peak among the 20 intergranular triple junctions 43. If analysis with high precision is required, the line analysis may be performed on more than 20 intergranular triple junctions 43. For example, the line analysis may be performed on 100 intergranular triple junctions 43 to count those having the Cu peak.

The absence of the Cu-segregated portion 50 in the grain boundary 42 can be confirmed based on the line profiles along the scanning line SL2 extending through the grain boundary 42 shown in FIG. 8, as described below. In FIG. 8, the region between the position at about 4 nm and the position at about 6.2 nm from the scan starting position corresponds to the grain boundary 42. The detection intensities of Ba and Ti in the grain boundary 42 is lower than those in the ceramic crystal grains 41, while the detection intensity of Ni in the grain boundary 42 is higher than that in the ceramic crystal grains 41. As shown in FIG. 8, the line profile of the Cu element reconstructed along the scanning line SL2 does not have any peaks in which the Cu count is at least 30% larger than the average Cu count in the Cu line profile. The absence of the peak in the line profile of the Cu element along the scanning line SL2 extending through the grain boundary 42 confirms the absence of the Cu-segregated portion 50 in the grain boundary 42. To determine that no Cu-segregated portion 50 is present in the grain boundary 42, a plurality of scanning lines SL2 extending through the grain boundary 42 may be set, and the absence of peaks may be confirmed in the reconstructed line profiles of the Cu element along the plurality of scanning lines. When setting a plurality of scanning lines SL2 for the same grain boundary between particles, the spacing between the scanning lines SL2 can be about 30 nm.

In TEM-EDS, a concentration map is obtained that expresses the concentration of the quantitative element in the observation region in terms of atomic percentage (at %). By setting the observation region to include the intergranular triple junction 43 and the grain boundary 42, the concentration of the quantitative element in the intergranular triple junction 43 can be compared with the concentration of the quantitative element in the grain boundary 42. In this specification, the concentration of Cu in the intergranular triple junction 43 may be referred to as the “first concentration”, and the concentration of Cu in the grain boundary 42 as the “second concentration”. In one embodiment, the concentration of Cu in the intergranular triple junction 43 (first concentration) is higher than the concentration of Cu in the grain boundary 42 (second concentration). The first concentration can be expressed, for example, in terms of the atomic percentage of Cu at the peak position of the Cu line profile along the scanning line SL1, calculated by taking the total number of atoms of the quantitative element as 100 at %. The average of the Cu concentration quantified in a plurality of intergranular triple junctions 43 included in the observation region may be taken as the first concentration. The second concentration can be expressed, for example, in terms of the atomic percentage of Cu at the central position of the grain boundary 42 on the scanning line SL2, calculated by taking the total number of atoms of the quantitative element as 100 at %. The average of the Cu concentration quantified at a plurality of positions within the grain boundaries 42 included in the observation region may be taken as the second concentration.

In one aspect, the concentration of Cu in the capacitance-generating portion Rc may be substantially equal to the concentration of Cu in the margins. When the concentration of Cu in the capacitance-generating portion Rc is 0.8 to 1.2 times the concentration of Cu in the margins, the concentration of Cu in the capacitance-generating portion Rc can be regarded as being substantially equal to the concentration of Cu in the margins. When comparing the concentration of Cu in the capacitance-generating portion Rc with the concentration of Cu in the margins, the concentrations in the corresponding regions are compared to each other. For example, when the concentration of Cu in the intergranular triple junction 43 included in the capacitance-generating portion Rc is 0.8 to 1.2 times the concentration of Cu in the intergranular triple junction 43 included in the margins, the concentration of Cu in the capacitance-generating portion Rc can be regarded as being substantially equal to the concentration of Cu in the margins. To confirm that the concentration of Cu in the capacitance-generating portion Rc is substantially equal to the concentration of Cu in the margins, the concentrations of Cu in the grain boundaries 42 may be compared to each other, or the concentrations of Cu in the ceramic crystal grains 41 may be compared to each other.

### (2) Manufacturing Method of Laminated Ceramic Capacitor 1

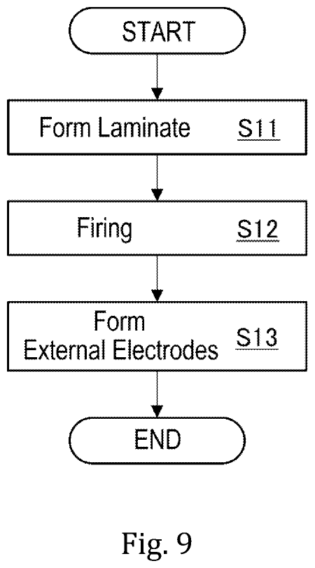

A description will now be given of one example of the manufacturing method of the laminated ceramic capacitor 1 with reference to FIG. 9. FIG. 9 is a flowchart showing a flow of a manufacturing method of a capacitor according to one embodiment of the disclosure.

Here is a brief description of the manufacturing method shown in FIG. 9. In step S11, a green laminate as the precursor of the body 10 is formed. The green laminate includes dielectric green sheets, which are the precursor of the dielectric layers 11, and internal electrode patterns, which are the precursor of the first and second internal electrode layers 21 and 22. The green laminate may be made by alternately stacking dielectric green sheets having internal electrode patterns on the surfaces thereof which are the precursor of the first internal electrode layers 21, and dielectric green sheets having internal electrode patterns on the surfaces thereof which are the precursor of the second internal electrode layers 22. At least one of the raw materials of the dielectric green sheets and the internal electrode patterns contains Cu added thereto. In the next step S12, the laminate made in the step S11 is heated in a firing furnace to fire the dielectric green sheets and internal electrode patterns. In this manner, the laminated ceramic capacitor 1 is manufactured.

The following describes each of the steps shown in FIG. 9 in more detail. First, in the step S11, ceramic powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain dielectric green sheets. The dielectric green sheets are the precursor of the dielectric layers 11.

The ceramic powder used as the raw powder of the dielectric green sheets is, for example, barium titanate powder. Barium titanate powder is synthesized by reacting titanium raw material such as titanium dioxide with barium raw material such as barium carbonate by a known method such as the solid phase method, the sol-gel method, or the hydrothermal method. The raw powder of the dielectric green sheets may contain Cu-containing powder (e.g., copper powder) or Cu-containing organometallic complex solution added thereto. The Cu-containing powder or organometallic complex solution is weighed so that the Cu content is equal to or larger than 0.1 at % and smaller than 0.4 at %, relative to the element entering the B site of the main component oxide (Ti in the case of barium titanate) at 100 at %. As discussed below, Cu may be added to the raw material of the internal electrode patterns.

Next, an internal electrode pattern is formed on each of the dielectric green sheets formed as described above. The internal electrode pattern is formed, for example, by printing a paste for the internal electrodes on the dielectric green sheet using screen printing or other known printing methods. The paste for the internal electrodes may be produced by kneading and mixing a metal powder, a binder resin, and a solvent by a three-roll mill. In the paste for the internal electrodes thus produced, the metal powder is dispersed in the binder resin. The paste for the internal electrodes contains Ni or Ni alloy as the main component thereof. The paste for the internal electrodes may contain Cu-containing powder or Cu-containing organometallic complex solution added thereto. The Cu-containing powder or organometallic complex solution is weighed so that the Cu content is equal to or larger than 1 at % and smaller than 8 at %, relative to the total content of the metal components contained in the paste for the internal electrodes at 100 at %. The organic binder used in the paste for the internal electrodes may be a cellulose-based resin such as ethyl cellulose or an acrylic resin such as butyl methacrylate. The internal electrode patterns formed on some of the dielectric green sheets are the precursor of the first internal electrode layers 21, and the internal electrode patterns formed on the others of the dielectric green sheets are the precursor of the second internal electrode layers 22.

A first dielectric green sheet has an internal electrode pattern, which is the precursor of the first internal electrode layer 21, formed thereon, and a second dielectric green sheet has an internal electrode pattern, which is the precursor of the second internal electrode layer 22, formed thereon. The second dielectric green sheet is stacked on the first dielectric green sheet to form a lamination unit, which includes the first and second dielectric green sheets stacked together. A predetermined number of lamination units are stacked together and thermo-compressed to form a mother laminate. Each of the dielectric green sheets included in the mother laminate has internal electrode patterns formed on the top surface and bottom surface thereof. The topmost layer and the bottommost layer of the green laminate may be formed of green sheets that do not have internal electrode patterns formed thereon.

Next, the mother laminate is diced into pieces to obtain chip-like green laminates each being the precursor of the body 10. The chip-like green laminates may be subjected to a degreasing process. The degreasing process may be performed in an N₂ atmosphere.

Next, in the step S12, each of the chip-like green laminates produced in the step S11 is placed in a firing furnace, and fired in the firing furnace, thereby producing the body 10. In this firing process, the dielectric green sheets in the chip laminate are fired into the dielectric layers 11, and the internal electrode patterns are fired into the internal electrode layers (the first internal electrode layers 21 and the second internal electrode layers 22). Cu added to at least one of the dielectric green sheets and the paste for the internal electrodes becomes a liquid phase during firing and spreads over the surface of the ceramic powder, thereby promoting sintering of the ceramic powder. The elements contained in the ceramic powder (Ba and Ti, if the ceramic powder is barium titanate powder) are eluted into the liquid-phase component, and the elements eluted into the liquid-phase component re-deposit on the crystal surface, such that the growth of the ceramic crystal grains 41 proceeds. In addition, as the rearrangement of the ceramic crystal grains 41 progresses in the liquid-phase component, the dielectric layers 11 are densified.

An example of the temperature profile for the firing is now described. The temperature in the firing furnace is raised from the room temperature to an intermediate temperature at the rate of 200 to 300° C./h. The intermediate temperature is set at slightly lower than the sintering temperature of the main component metal element. When the main component metal element is Ni, the intermediate temperature is set at about 500 to 700° C. An example of the intermediate temperature is 600° C. The temperature in the firing furnace is then increased from the intermediate temperature to a firing top temperature at a fast rate of 30,000° C./h or higher. The firing top temperature is, for example, 1200 to 1400° C. An example of the firing top temperature is 1300° C. The firing top temperature is maintained for a duration of within 10 seconds to prevent excessive sintering of the internal electrode layers. Cooling may start immediately after the firing top temperature is reached.

During the firing process, Cu atoms in the liquid phase spread over the surface of the ceramic powder. When the temperature increase rate is low, the Cu atoms that are spread over the surface of the ceramic powder form a compound with the elements contained in the ceramic powder, and this compound is incorporated into the shell portion of the ceramic crystal grains 41. If the Cu atoms incorporated in the shell portion are extruded into the grain boundaries 42 after cooling, Cu-segregated portions 50 may possibly be formed in the grain boundaries 42. In addition, when the temperature increase rate is low, Cu atoms tend to remain in the grain boundaries 42 until the end of the firing process. Therefore, the Cu atoms in the liquid phase may possibly deposit into the grain boundaries 42 after cooling, forming the Cu-segregated portions in the grain boundaries 42. On the other hand, in the embodiment of the disclosure, the temperature is increased at a fast rate of 30,000° C./h or higher from the intermediate temperature to the firing top temperature, allowing the ceramic crystal grains 41 to grow in a short time. The inventor found that the temperature increase rate of 30,000° C./h or higher causes the Cu atoms in the liquid phase to be extruded from the grain boundaries 42 to the intergranular triple junctions 43 by the fast growing ceramic crystal grains 41 before being incorporated into the shell portion, resulting in no segregation of Cu in the grain boundaries 42. When the temperature increase rate is 30,000° C./h or higher, the Cu atoms in the liquid phase are extruded into the intergranular triple junctions 43, so the Cu-segregated portions 50 are not contained in the grain boundaries 42, but in the intergranular triple junctions 43.

Next, in step S13, the first external electrode 31 and the second external electrode 32 are formed on the body 10 obtained in step S12, to form the laminated ceramic capacitor 1. The first external electrode 31 and the second external electrode 32 may be formed by any known method.

Processes not shown in the flowchart of FIG. 9 may be performed to produce the laminated ceramic capacitor 1. For example, the laminated ceramic capacitor 1 obtained through the firing in the step S12 may be subjected to re-oxidation treatment at 600° C. to 1000° C. in an N₂ gas atmosphere.

### (3) Examples

The invention will now be further described in detail based on examples. The invention is not limited to the following examples.

### (3-1) Preparation of Samples

To evaluate the bending strength and bias characteristics of the laminated ceramic capacitor 1, four types of samples (samples 1 to 4) were prepared according to the manufacturing method described above.

### Sample 1

To prepare the laminated ceramic capacitor of sample 1, barium titanate powder and copper powder were weighed so that the content of Cu relative to Ti at 100 at % is 0.25 at %, and these powders weighed were mixed. Each of these powder mixtures was wet-mixed with polyvinyl butyral (PVB) resin, a solvent, and a plasticizer to obtain a slurry. The slurry was coated on a substrate film, and then the slurry coated on the substrate film was dried to obtain a plurality of dielectric green sheets.

Next, a paste for internal electrodes in which Ni was dispersed in a binder resin was printed onto each of the above dielectric green sheets.

Next, 500 dielectric green sheets each having the paste for internal electrodes printed thereon were stacked together to form a green laminate. Next, the green laminate is diced into pieces to obtain chip-like green laminates. The chip-like green laminates had the 1005 shape (length: 1.0 mm, width: 0.5 mm, height: 0.5 mm). Next, the chip-like green laminates were degreased in an N₂ atmosphere. Following this, metal paste was applied to the degreased green laminates by the dip method, to form base layers of the external electrodes on the green laminates.

Next, the chip-like green laminates obtained as descried above were subjected to heat treatment according to the following heating conditions.
Atmosphere: low-oxygen atmosphere (oxygen partial pressure of 10-10 MPa)
Temperature profile
   Temperature increase rate from the room temperature to the intermediate temperature (600° C.): 300° C./h
   Temperature increase rate from the intermediate temperature to the firing top temperature (1300° C.): 30,000° C./h
Duration of maintaining the firing top temperature: 10 sec.

The laminated ceramic capacitor of sample 1 was prepared in the above manner.

### Sample 2

The laminated ceramic capacitor of sample 2 was prepared. The manufacturing conditions for sample 2 were the same as those for sample 1, except that the temperature increase rate from the intermediate temperature to the firing top temperature was changed from 30,000° C./h to 15,000° C./h.

### Sample 3

The laminated ceramic capacitor of sample 3 was prepared. The manufacturing conditions for sample 3 were the same as those for sample 1, except that copper powder was not contained in the raw material of the dielectric green sheets.

### Sample 4

The laminated ceramic capacitor of sample 4 was prepared. The manufacturing conditions for sample 4 were the same as those for sample 2, except that copper powder was not contained in the raw material of the dielectric green sheets.

### (3-2) Measurement of Cu Concentrations in Grain Boundary and Intergranular Triple Junction and Observation of Cu-Segregated Portion

The concentrations of Cu contained in samples 1 to 4 were measured as follows. First, each of samples 1 to 4 was sliced using a focused ion beam (FIB) system so that an LT surface can be used as the observation surface, and a sliced analysis specimen with a thickness of 60 nm was taken from each of samples 1 to 4. Damage that appeared in the observation surfaces of the sliced specimens was removed as appropriate by Ar ion milling. Next, the sliced analysis specimen was placed in an EDS detector (JED-2300T Dry SD160 Detector DualSDD System from JEOL Ltd.) in a TEM (JEM-ARM200F from JEOL Ltd.), and ten observation regions B (each corresponding to the observation region B in FIG. 6) of 15 nm square extending from an internal electrode layer to a dielectric layer were set and subjected to EDS analysis. The EDS analysis was performed with the acceleration voltage of 200 kV and the electron beam diameter of 1.5 nm for a duration of 3 hours. This EDS analysis resulted in concentration maps for each of the observation regions B, representing the concentrations of the quantitative elements (Ba, Ti, Ni, and Cu) in atomic percentage (at %). The Cu concentrations in the grain boundaries 42 and in the intergranular triple junction 43 in the concentration maps obtained are listed in Table 1 for each sample.

As listed in Table 1, for sample 1, the Cu concentration in the intergranular triple junction 43 was 0.35 at %, but no Cu was detected in the grain boundaries 42 (denoted “N.D.” in Table 1). The reason why Cu was detected in the intergranular triple junction 43 and not in the grain boundaries 42 is probably that during the manufacturing process of sample 1, the firing furnace was heated from the intermediate temperature to the firing top temperature at a high rate of 30,000° C./h, which caused rapid growth of the ceramic crystal grains 41, and Cu in the liquid phase was extruded from the grain boundaries 42 to the intergranular triple junction 43.

For sample 2, the Cu concentration in the grain boundaries 42 was higher than that in the intergranular triple junction 43. In the manufacturing process of sample 2, the firing furnace was heated at a lower temperature increase rate (15,000° C./h) than for sample 1, so it is probable that some of Cu atoms in the liquid phase remained in the grain boundaries 42 during the firing process, and these Cu atoms deposited in the grain boundaries 42 after cooling.

For samples 3 and 4, Cu was not detected in either the grain boundaries 42 or the intergranular triple junction 43, because copper powder was not added to the raw material of the dielectric green sheets.

The concentration maps obtained for each sample were reconstructed along each of the scanning line SL1 that extends through the intergranular triple junction 43 and the scanning line SL2 that extends through the grain boundary 42, to obtain a line profile of each quantitative element for each of the observation regions B. In the line profile along the scanning line SL1 of sample 1, the Cu peak appeared at a position within the intergranular triple junction 43, generally as in FIG. 7. No Cu peaks appeared in the line profile along the scanning line SL2 of sample 1. For sample 1, Cu peaks appeared in both the line profiles along the scanning line SL1 and the scanning line SL2. For samples 3 and 4, line analysis was omitted because Cu was not added.

The above results confirmed that in sample 1, for which the temperature was increased during firing at a high rate of 30,000° C./h, the Cu-segregated portion was contained in the intergranular triple junction 43, but not in the grain boundaries 42. The analysis of sample 2 confirmed that with the temperature increase rate of about 15,000° C./h, the Cu-segregated portions were also contained in the grain boundaries 42. Therefore, it was found that in order to ensure that the Cu-segregated portions are contained in the intergranular triple junction 43 but not in the grain boundaries 42, it is necessary to increase the temperature of the firing furnace at a fast rate of 30,000° C./h or higher during firing.

### (3-3) Measurement of Bias Characteristics

Ten pieces were selected for each of samples 1 to 4, and the bias characteristics were evaluated for each of these selected pieces. Specifically, 3V DC voltage was applied to each piece, and capacitance was measured by an LCR meter at 1 kHz and 0.5 Vrms. The relative permittivity of the dielectric layers was then calculated for each piece based on the effective area of the internal electrode layers, the number of layers, the thickness of the dielectric layers, and the vacuum permittivity, as well as the measured capacitance of the piece. The average value of the relative permittivity thus calculated for each of the ten pieces was determined, and this average value was taken as the relative permittivity of the sample. The relative permittivity calculated for each sample was then normalized relative to the relative permittivity calculated for sample 3 set at 100, and the normalized relative permittivities were listed in the “Bias Characteristics” column of Table 1. Comparing sample 1 and sample 2, in which copper powder was added to the raw material of the dielectric green sheets, the bias characteristics of sample 1 are better, while those of sample 2 are worse, than those of sample 3. In sample 2, the bias characteristics were degraded probably due to the Cu-segregated portions contained in the grain boundaries 42. On the other hand, in sample 1, the bias characteristics were not degraded probably because no Cu-segregated portions were contained in the grain boundaries 42.

### (3-4) Measurement of Bending Strength

Twenty pieces were selected for each of samples 1 to 4, and the bending strength was measured for each of these selected pieces. Each piece was placed on a rigid plate, and the center of the top surface of each piece was pressed with a jig to measure the maximum stress that led to fracture. The average value of the bending strength thus measured for each of the 20 pieces was determined, and this average value was taken as the bending strength of the sample. The bending strength measured for each sample was then normalized relative to the bending strength measured for sample 3 set at 100, and the normalized bending strengths were listed in the “Bending Strength” column of Table 1. The bending strengths of samples 1 and 2, in which copper powder was added to the raw material of the dielectric green sheets, were improved compared to those of samples 3 and 4, in which copper powder was not added to the raw material of the dielectric green sheets. The copper powder becomes a liquid phase during firing and promotes densification of the dielectric layers 11, and therefore, the dielectric layers 11 of samples 1 and 2 are more densified than the dielectric layers 11 of samples 3 and 4. In samples 1 and 2, the densification of the dielectric layers 11 probably improved the bending strength.

### (3-5) HALT

One hundred pieces were selected for each of samples 1 to 4, and an accelerated life test (HALT) was performed on each of these selected pieces. In the accelerated life test, a voltage of 6 V was applied at 125° C. to the 100 pieces selected for each of samples 1 to 4, and the failure time was measured. The median of the failure time measured for each of these 100 pieces was taken as the HALT 50% value of the sample. The HALT 50% value calculated for each sample was then normalized relative to the HALT 50% value calculated for sample 3 set at 100, and the normalized HALT 50% values were listed in the “HALT Life” column of Table 1. The HALT lives of samples 1 and 2, in which copper powder was added to the raw material of the dielectric green sheets, were improved compared to those of samples 3 and 4, in which copper powder was not added to the raw material of the dielectric green sheets.

TABLE 1

| | | Cu Concentration | | | |
|---|---|---|---|---|---|
| | Cu Concentration | (Intergranular | Bias | Bending | HALT |
| | (Grain Boundary) | Triple Junction) | Characteristics | Strength | Life |
| Sample 1 | N.D. | 0.35% | 105 | 108 | 135 |
| (Embodiment) | | | | | |
| Sample 2 | 0.26% | 0.21% | 82 | 105 | 123 |
| (Comparative | | | | | |
| Example) | | | | | |
| Sample 3 | N.D. | N.D. | 100 | 100 | 100 |
| (Comparative | | | | | |
| Example) | | | | | |
| Sample 4 | N.D. | N.D. | 102 | 89 | 98 |
| (Comparative | | | | | |
| Example) | | | | | |

### (3-6) Concluding Remarks

The above experimental results show that in sample 1, the Cu atoms added to the raw material of the ceramic green sheets act as a sintering agent during firing, which promotes the growth and rearrangement of the ceramic crystal grains 41 and densifies the dielectric layers 11. As a result, the bending strength and HALT life were improved compared to those of samples 3 and 4, in which Cu was not added to the raw material of the ceramic green sheets. In sample 1, no Cu-segregated portions 50 were present in the grain boundaries 42 of the ceramic crystal grains, and therefore, the bias characteristics were not degraded compared to sample 3, in which Cu was not added. In addition, the bias characteristics of sample 1 were significantly improved compared to sample 2, which contains Cu-segregated portions in the grain boundaries.

### (4) Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) Additional Embodiments

Embodiments disclosed herein also include the following.

### Additional Embodiment 1

A laminated ceramic capacitor (1) comprising:
a body (10) including a first internal electrode layer (21), a second internal electrode layer (22), and a dielectric layer (11), the first internal electrode layer being mainly composed of Ni or Ni alloy, the second internal electrode layer being mainly composed of Ni or Ni alloy, the dielectric layer being disposed between the first internal electrode layer and the second internal electrode layer in a first direction (T), the dielectric layer containing a plurality of ceramic crystal grains (41);
a first external electrode (31) provided on the body so as to be electrically connected to the first internal electrode layer; and
a second external electrode (32) provided on the body so as to be electrically connected to the second internal electrode layer,
wherein the dielectric layer has a plurality of intergranular triple junctions (43), each disposed among three or more adjacent ceramic crystal grains included in the plurality of ceramic crystal grains, and at least a part of the plurality of intergranular triple junctions contains a Cu-segregated portion in which Cu is segregated, while a grain boundary (42) disposed between two adjacent ceramic crystal grains included in the plurality of ceramic crystal grains does not contain a Cu-segregated portion.

### Additional Embodiment 2

The laminated ceramic capacitor of Additional Embodiment 1, wherein a first concentration which indicates a concentration of Cu in the grain boundary is lower than a second concentration which indicates a concentration of Cu in the plurality of intergranular triple junctions.

### Additional Embodiment 3

The laminated ceramic capacitor of Additional Embodiment 1 or 2, wherein dimensions of the first internal electrode layer and the second internal electrode layer in the first direction are equal to or smaller than 0.6 μm.

### Additional Embodiment 4

The laminated ceramic capacitor of Additional Embodiment 1 or 2, wherein a dimension of the dielectric layer in the first direction is equal to or smaller than 0.8 μm.

### Additional Embodiment 5

The laminated ceramic capacitor of Additional Embodiment 1 or 2, wherein the plurality of ceramic crystal grains are mainly composed of barium titanate.

### Additional Embodiment 6

The laminated ceramic capacitor of Additional Embodiment 1 or 2,
wherein the body is partitioned into a capacitance-generating portion and a margin, the capacitance-generating portion including the first internal electrode layer and the second internal electrode layer facing each other in the first direction, the margin surrounding the capacitance-generating portion, and
wherein a concentration of Cu in the capacitance-generating portion is 0.8 to 1.2 times a concentration of Cu in the margin.

### Additional Embodiment 7

A circuit module comprising the laminated ceramic capacitor of Additional Embodiment 1.

### Additional Embodiment 8

An electronic device comprising the circuit module of Additional Embodiment 7.

### Additional Embodiment 9

A method of manufacturing a laminated ceramic capacitor, the method comprising:
forming a green laminate, the green laminate including a ceramic green sheet and internal electrode patterns, the ceramic green sheet containing a ceramic material made of a ceramic oxide represented by a chemical formula ABO₃, mixed with Cu at a proportion equal to or larger than 0.1 at % and smaller than 0.4 at % relative to a B-site element at 100 at %, the internal electrode patterns being provided on a first surface and a second surface of the ceramic green sheet, the internal electrode patterns being mainly composed of Ni or Ni alloy (S11);
increasing a temperature of a firing furnace having the green laminate placed therein, to a firing top temperature at a rate of 30,000° C./h or higher; and
firing the green laminate by keeping an inside of the firing furnace at the firing top temperature.

### Additional Embodiment 10

The method of manufacturing a laminated ceramic capacitor according to Additional Embodiment 9, wherein the internal electrode patterns contain Cu at a proportion equal to or larger than 1 at % and smaller than 8 at % relative to a total content of metal components contained in the internal electrode patterns at 100 at %.

### Additional Embodiment 11

A method of manufacturing a laminated ceramic capacitor, the method comprising:
preparing a green laminate, the green laminate including a ceramic green sheet and internal electrode patterns, the ceramic green sheet being mainly composed of a ceramic oxide represented by a chemical formula ABO₃, the internal electrode patterns being provided on a first surface and a second surface of the ceramic green sheet, the internal electrode patterns containing Cu at a proportion equal to or larger than 1 at % and smaller than 8 at % relative to a total content of metal components at 100 at %;
increasing a temperature of a firing furnace having the green laminate placed therein, to a firing top temperature at a rate of 30,000° C./h or higher; and
firing the green laminate by keeping an inside of the firing furnace at the firing top temperature.

What is claimed is:

1. A laminated ceramic capacitor comprising:
a body including a first internal electrode layer, a second internal electrode layer, and a dielectric layer, the first internal electrode layer being mainly composed of Ni or Ni alloy, the second internal electrode layer being mainly composed of Ni or Ni alloy, the dielectric layer being disposed between the first internal electrode layer and the second internal electrode layer in a first direction, the dielectric layer containing a plurality of ceramic crystal grains;
a first external electrode provided on the body so as to be electrically connected to the first internal electrode layer; and
a second external electrode provided on the body so as to be electrically connected to the second internal electrode layer,
wherein the dielectric layer has a plurality of intergranular triple junctions, each disposed among three or more adjacent ceramic crystal grains included in the plurality of ceramic crystal grains, and at least a part of the plurality of intergranular triple junctions contains a Cu-segregated portion in which Cu is segregated, while a grain boundary disposed between two adjacent ceramic crystal grains included in the plurality of ceramic crystal grains does not contain a Cu-segregated portion.

2. The laminated ceramic capacitor of claim 1, wherein a first concentration which indicates a concentration of Cu in the grain boundary is lower than a second concentration which indicates a concentration of Cu in the plurality of intergranular triple junctions.

3. The laminated ceramic capacitor of claim 1, wherein dimensions of the first internal electrode layer and the second internal electrode layer in the first direction are equal to or smaller than 0.6 μm.

4. The laminated ceramic capacitor of claim 1, wherein a dimension of the dielectric layer in the first direction is equal to or smaller than 0.8 μm.

5. The laminated ceramic capacitor of claim 1, wherein the plurality of ceramic crystal grains are mainly composed of barium titanate.

6. The laminated ceramic capacitor of claim 1,
wherein the body is partitioned into a capacitance-generating portion and a margin, the capacitance-generating portion including the first internal electrode layer and the second internal electrode layer facing each other in the first direction, the margin surrounding the capacitance-generating portion, and
wherein a concentration of Cu in the capacitance-generating portion is 0.8 to 1.2 times a concentration of Cu in the margin.

7. A circuit module comprising the laminated ceramic capacitor of claim 1.

8. An electronic device comprising the circuit module of claim 7.

9. A method of manufacturing a laminated ceramic capacitor, the method comprising:
forming a green laminate, the green laminate including a ceramic green sheet and internal electrode patterns, the ceramic green sheet containing a ceramic material made of a ceramic oxide represented by a chemical formula ABO₃, mixed with Cu at a proportion equal to or larger than 0.1 at % and smaller than 0.4 at % relative to a B-site element at 100 at %, the internal electrode patterns being provided on a first surface and a second surface of the ceramic green sheet, the internal electrode patterns being mainly composed of Ni or Ni alloy;
increasing a temperature of a firing furnace having the green laminate placed therein, to a firing top temperature at a rate of 30,000° C./h or higher; and
firing the green laminate by keeping an inside of the firing furnace at the firing top temperature.

10. The method of manufacturing a laminated ceramic capacitor according to claim 9, wherein the internal electrode patterns contain Cu at a proportion equal to or larger than 1 at % and smaller than 8 at % relative to a total content of metal components contained in the internal electrode patterns at 100 at %.

11. A method of manufacturing a laminated ceramic capacitor, the method comprising:
preparing a green laminate, the green laminate including a ceramic green sheet and internal electrode patterns, the ceramic green sheet being mainly composed of a ceramic oxide represented by a chemical formula ABO₃, the internal electrode patterns being provided on a first surface and a second surface of the ceramic green sheet, the internal electrode patterns containing Cu at a proportion equal to or larger than 1 at % and smaller than 8 at % relative to a total content of metal components at 100 at %;
increasing a temperature of a firing furnace having the green laminate placed therein, to a firing top temperature at a rate of 30,000° C./h or higher; and
firing the green laminate by keeping an inside of the firing furnace at the firing top temperature.
